(19) United States
(12) Patent Application Publication
(10) Pub. No.: US 2014/0172222 A1
(43) Pub. Date: Jun. 19, 2014

(54) SPEED CONTROL IN AGRICULTURAL VEHICLE GUIDANCE SYSTEMS

(71) Applicant: AGCO Corporation, Duluth, GA (US)

(72) Inventor: Vincent Nickel, Peabody, KS (US)

(73) Assignee: AGCO Corporation, Duluth, GA (US)

(21) Appl. No.: 14/109,229

(22) Filed: Dec. 17, 2013

Related U.S. Application Data
(60) Provisional application No. 61/739,274, filed on Dec. 19, 2012.

(51) Int. Cl. G05D 13/00; G05D 1/02

(52) U.S. Cl. CPC G05D 13/00; G05D 1/02
USPC 701/23

(57) ABSTRACT

Speed control in agricultural vehicle guidance systems may be provided. First, an auto-guidance processor may load a wayline and topographical data of an area where an agricultural vehicle may be located. A drive component coupled to the auto-guidance processor may be engaged to cause the agricultural vehicle to traverse the wayline at a speed. The wayline may define a path for the agricultural vehicle to travel within the area. The speed may be based upon the topographical data. The auto-guidance processor may receive inclination data. The agricultural vehicle's speed may be altered as the agricultural machine traverses the wayline based upon the inclination data.

### CROSS REFERENCE TO RELATED APPLICATION

This application claims the benefit of U.S. Provisional Application No. 61/739,274, entitled SPEED CONTROL IN AGRICULTURAL VEHICLE GUIDANCE SYSTEMS filed Dec. 19, 2012, which is hereby incorporated by reference in its entirety.

### BACKGROUND OF THE INVENTION

1. Field of Invention

This invention relates to speed control in agricultural vehicle guidance systems, and more particularly to using inclination data to control the speed the agricultural vehicle may traverse a wayline.

2. Description of Related Art

Vehicle guidance systems are used in many types of agricultural vehicles to assist operators in reaching a desired location and/or following a desired path. For instance, vehicle guidance systems may use control algorithms to direct agricultural vehicles from point to point. In other words, tractors, combines, sprayers, and other agricultural vehicles may be equipped with vehicle guidance systems to assist operators in following a desired route across a field.

### OVERVIEW OF THE INVENTION

In one embodiment, the invention is directed to a method for speed control in agricultural vehicle guidance systems. First, an auto-guidance processor may load a wayline and topographical data of an area where an agricultural vehicle may be located. A drive component coupled to the auto-guidance processor may be engaged to cause the agricultural vehicle to traverse the wayline at a speed. The wayline may define a path for the agricultural vehicle to travel within the area. The speed may be based upon the topographical data. The auto-guidance processor may receive inclination data. The agricultural vehicle's speed may be altered as the agricultural machine traverses the wayline based upon the inclination data.

Another embodiment may comprise an inertial sensor system, a drive component operative to propel an apparatus and an auto-guidance processor coupled to the drive component and the inertial sensor system. The auto-guidance processor may be operative to load a wayline and topographical data. The drive component coupled to the auto-guidance processor may be engaged to cause the agricultural vehicle to traverse the wayline at a speed based upon the topographical data. The wayline may define a path for the agricultural vehicle to travel within the area. The speed may be based upon the topographical data. The auto-guidance processor may be operative to receive inclination data from the inertial sensor system and alter the agricultural vehicle's speed based upon the inclination data.

Yet another embodiment may comprise a memory storage and a processing unit coupled to the memory storage. The processing unit may be operative to load a wayline and topographical data. The wayline may define a path for the apparatus to follow. The processing unit may be further operative to engage a drive component to propel the apparatus along the wayline at a speed and receive inclination data from an inertial sensor system. The speed may be based upon the topographical data. The speed may be altered by the processing unit as the apparatus follows the wayline based on the inclination data.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIGS. 1A and 1B show an operating environment;

FIG. 2 shows an auto-guidance processor;

FIG. 3 shows a flow chart of a method for providing speed control in agricultural vehicle guidance systems and

FIG. 4 shows a flow chart of a subroutine for altering speed.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following

### DETAILED DESCRIPTION

Speed control in agricultural vehicle guidance systems may be provided. First, an auto-guidance processor may load a wayline and topographical data of an area where an agricultural vehicle may be located. A drive component coupled to the auto-guidance processor may be engaged to cause the agricultural vehicle to traverse the wayline at a speed. The wayline may define a path for the agricultural vehicle to travel within the area. The speed may be based upon the topographical data. The auto-guidance processor may receive inclination data. The agricultural vehicle's speed may be altered as the agricultural machine traverses the wayline based upon the inclination data.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### EXAMPLE EMBODIMENTS

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

An auto-guidance system may automatically steer an agricultural vehicle (e.g., a tractor, a combine, or a sprayer) along a predefined path (e.g., a wayline) within an area (e.g., a farm or field). The area may have a topology that may necessitate the agricultural vehicle operating at different speeds. For example, when the agricultural vehicle is operating on a hillside, a slower speed may be needed to maintain the agricultural vehicle's stability.

The auto-guidance system may load a wayline and topographical data for the area in which the agricultural vehicle may be located. As the agricultural vehicle traverses the wayline, the auto-guidance system may alter agricultural vehicle's speed based upon the topographical data. The topographical data may comprise data describing terrain elevation and/or elevation changes. For example, the topology data may contain data describing an approximate height above a reference datum at various locations and/or elevation changes from one location to another within the area. In addition, the topographical data may comprise data representing performance specifications such as a speed for the agricultural vehicle. For example, the topographical data may comprise data specifying the agricultural vehicle is to traverse a wayline at 12 mph for a given terrain contour and 20 mph for another terrain contour.

The auto-guidance system may receive inclination data from an inertial sensor system. The inertial sensor system may comprise, for example, motion sensors, accelerometers, rotation sensors, and gyroscopes. The inertial sensor system may monitor, continuously or intermittently, the agricultural vehicle's position, orientation, and velocity. As the agricultural vehicle traverses the wayline, the auto-guidance system may alter the agricultural vehicle's speed based upon the inclination data.

The inclination data may comprise data describing the agricultural vehicle's orientation with respect to predefined axes. For example, the inclination data may contain data describing the agricultural vehicle's pitch and roll angles relative to horizontal and vertical axes. In addition, the inclination data may comprise data describing rate changes in the agricultural vehicle's pitch and roll angles. For example, the inclination data may comprise data specifying how fast the agricultural vehicle's pitch and roll angles may be changing.

The inclination data may be directly measured or a calculated value. For example, the agricultural vehicle's inclination angle and/or rate of change of inclination may be directly measured. In addition, using the inclination angle, the rate of change of inclination may be calculated.

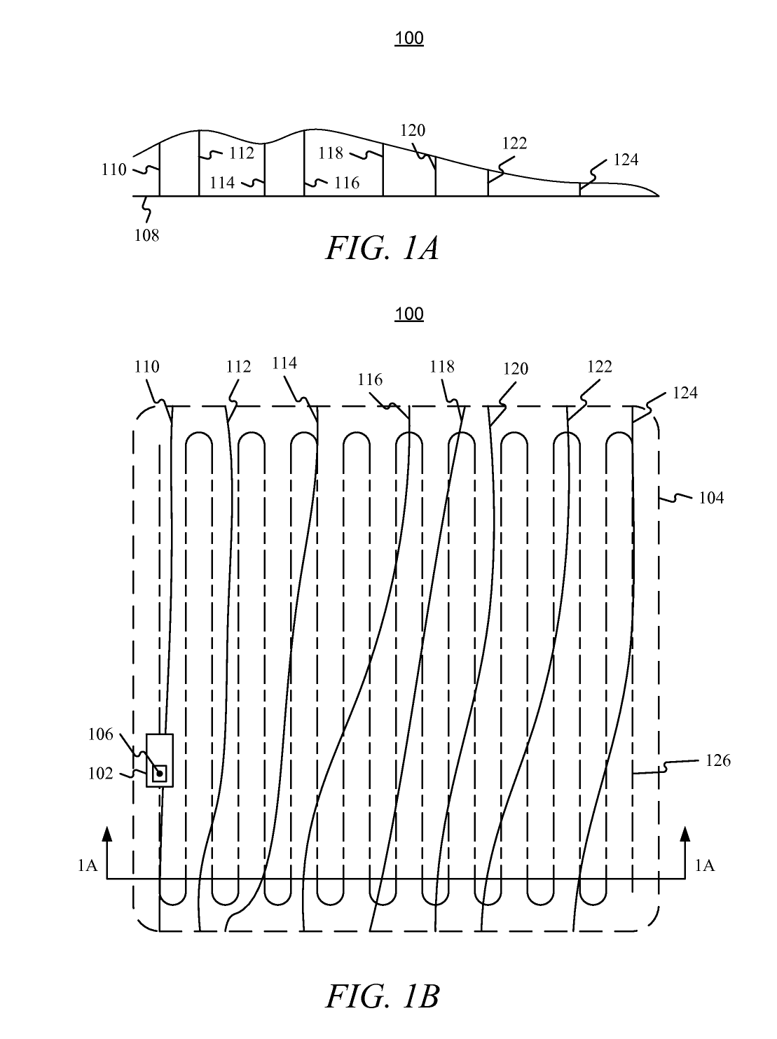

FIGS. 1A and 1B show an operating environment 100 (e.g., a farm) for providing speed control in agricultural vehicles. Operating environment 100 may comprise an agricultural vehicle 102 operating within an area (e.g., a field 104). Agricultural vehicle 102 may comprise an auto-guidance processor 106. Examples of agricultural vehicle 102 may include an agricultural implement, comprising, but not limited to, a tractor, a combine, or a sprayer.

Field 104 may comprise terrain at varying heights above a reference datum 108. Reference datum 108 may be any arbitrary point comprising, but not limited to, sea level, a lowest point in field 104, or a highest point in field 104. The varying heights may be represented by a plurality of contour lines (e.g., a first contour line 110, a second contour line 112, a third contour line 114, a fourth contour line 116, a fifth contour line 118, a sixth contour line 120, a seventh contour line 122, and an eighth contour line 124). In other words, each of the plurality of contour lines may represent a particular height above reference datum 108 or each contour line may represent an increase or decrease in elevation (e.g., ±25 feet). For example, first contour line 110, third contour line 114, and fifth contour line 118 may represent a distance of 100 feet above reference datum 108 and second contour line 112 may represent a +25 feet increase to 125 feet above reference datum 108.

A wayline 126 may traverse field 104. Wayline 126 may define a predetermined path agricultural vehicle 102 may travel. While FIG. 1B shows a single wayline, field 104 may comprise multiple waylines. The waylines may be straight, curved, etc.

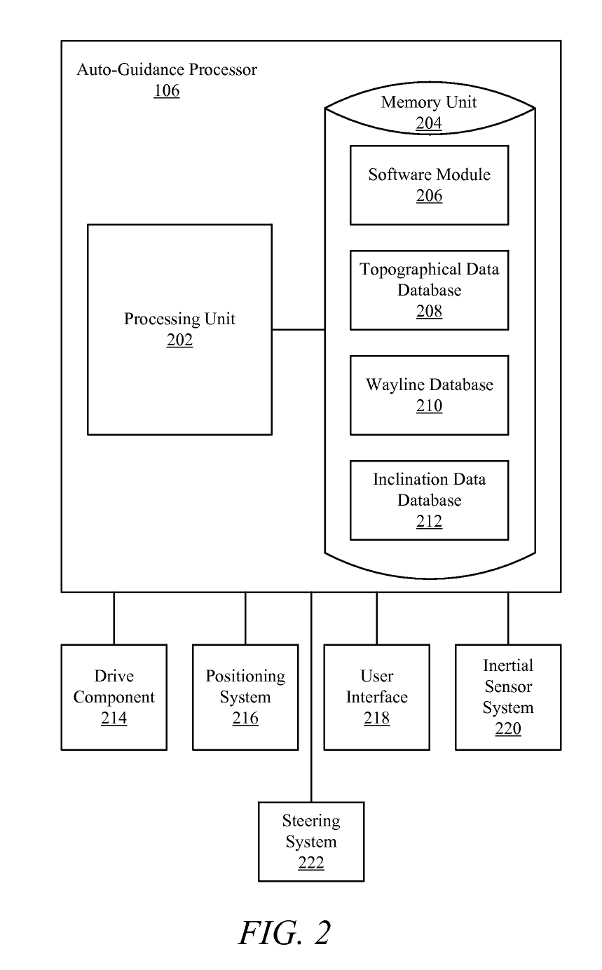

FIG. 2 shows auto-guidance processor 106 in more detail. As shown in FIG. 2, auto-guidance processor 106 may include a processing unit 202 and a memory unit 204. Memory unit 204 may include a software module 206, a topographical data database 208, a wayline database 210, and an inclination data database 212. Topographical data database 208 may comprise a plurality of topographical data. Wayline database 210 may comprise data on a plurality of waylines. Inclination data database 212 may comprise a plurality of inclination data such as, for example, maximum speeds for given inclination angles or rates of change in inclination angles. Wayline database 210 may comprise data on a plurality of waylines.

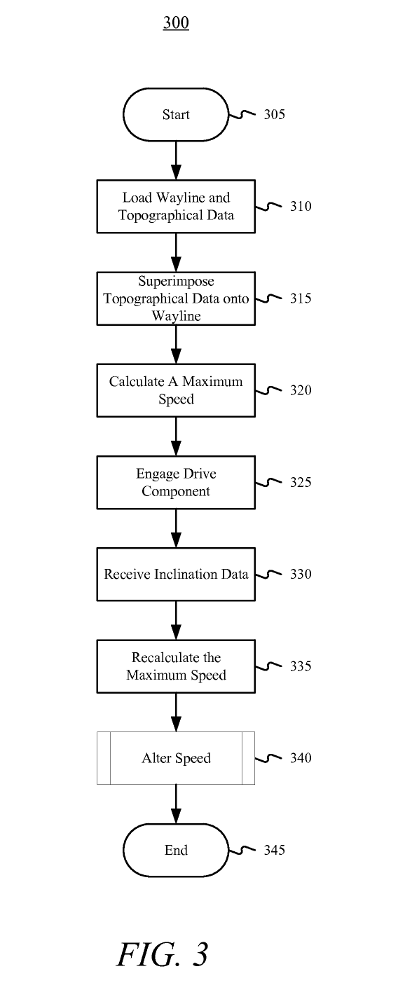

Auto-guidance processor 106 may also be operatively connected a drive component 214. Drive component 214 may comprise an engine and a steering linkage (not shown) for controlling movement of agricultural vehicle 102. While executing on processing unit 202, software module 206 may perform processes for providing speed control in agricultural vehicle guidance systems, including, for example, one or more stages included in method 300 described below with respect to FIG. 3.

A positioning system 216 may be connected to auto-guidance processor 106. Positioning system 216 may determine the location of agricultural vehicle 102 or receiving information that may be used to determine agricultural vehicle 102's position. Examples of positioning system 216 may include, for example, the Global Positioning System (GPS), cellular signals, etc.

A user interface 218 may be connected to auto-guidance processor 106. User interface 218 may allow an operator to input data into auto-guidance processor 106 through a keypad, a touch screen, etc. In addition, user interface 218 may allow auto-guidance processor 106 to present information to the operator, for example, via a display. For example, the operator may use user interface 218 to input speed data and user interface 218 may present the operator with visual and audible alarms when agricultural vehicle 102 exceeds a maximum speed.

An inertial sensor system 220 may be connected to auto-guidance processor 106. The inertial sensor system may comprise, for example, motion sensors, accelerometers, rotation sensors, and gyroscopes. The inertial sensor system may monitor, continuously or intermittently, the agricultural vehicle's position, orientation, and velocity. As the agricultural vehicle 102 traverses wayline 126, the auto-guidance system may alter agricultural vehicle 102's speed based upon the inclination data.

A steering system 222 may be connected to auto-guidance processor 106. Steering system 222 may comprise, for example, servos, motors, and sensors that may be connected to steering components (e.g., rack and pinion, steering linkages, etc.). Steering system 222 may monitor, continuously or intermittently, agricultural vehicle 102's trajectory and adjust wheel orientation to guide agricultural vehicle 102's trajectory. For instance, as the agricultural vehicle 102 traverses wayline 126, steering system 222 may alter agricultural vehicle 102's trajectory to follow wayline 126.

Topographical data database 208 may store topographical data associated with field 104. For instance, the contour data shown in FIGS. 1A and 1B may be stored in topographical data database 208. The topographical data may be stored as a topographical map, an array comprising latitude, longitude, and elevation, or an equation mapping field 104's topography. In addition, wayline 126 may be stored in topographical data database 208.

In addition to topographical data, topographical data database 208 may store maximum speeds for a given location within field 104. For example, topographical data database 208 may comprise an array. Within the array, in addition to latitude, longitude, and elevation, a maximum speed may be stored. The maximum speed may be based on multiple parameters such as, for example, agricultural vehicle type and weight, loading, and stability characteristics. The agricultural vehicle type and weight, loading, and stability characteristics may be indices within the array.

The data stored in topographical data database 208 may be updated in real-time. For instance, if agricultural vehicle 102 is a sprayer, the sprayer's weight, loading, and stability characteristics may change as it traverses field 104. Auto-guidance processor 106 may update topographical data database 208 to reflect the changes.

Inclination data database 212 may store maximum speeds for given inclination angles of agricultural vehicle 102. For example, inclination data database 212 may comprise an array. Within the array, inclination angles may be stored with corresponding maximum speeds. The maximum speeds may be based on multiple parameters such as, for example, agricultural vehicle type, weight, loading, and stability characteristics. The agricultural vehicle type and weight, loading, and stability characteristics may be indices within the array. In addition to inclination angles, maximum speeds for rates of change in agricultural vehicle 102's inclination angle may be store in inclination data database 212.

The data stored in inclination data database 212 may be updated in real-time. For instance, if agricultural vehicle 102 is a sprayer, the sprayer's weight, loading, and stability characteristics may change as it traverses field 104. Auto-guidance processor 106 may update inclination data database 212 to reflect the changes.

Auto-guidance processor 106 (“the processor”) may be implemented using an onboard engine control unit (ECU), a personal computer, a network computer, a mainframe, or other similar microcomputer-based workstation. The processor may be located on agricultural vehicle 102 or may be in a remote location. For instance, in an agricultural environment, the processor may comprise a computer located at a central location (e.g., a farm's central equipment storage and maintenance facility).

The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, or a wireless fidelity (Wi-Fi) access point. The aforementioned systems and devices are examples and the processor may comprise other systems or devices.

FIG. 3 is a flow chart setting forth the general stages involved in a method 300 for providing speed control in agricultural vehicle guidance systems. Method 300 may be implemented using, for example, auto-guidance processor 106 as described in more detail above. Ways to implement the stages of method 300 will be described in greater detail below.

Method 300 may begin at starting block 305 and proceed to stage 310 where auto-guidance processor 106 may load a wayline and topographical data. The wayline and topographical data may be selected from the plurality of waylines stored in wayline database 210 and the plurality of topographical data stored in topographical data database 208. The operator or auto-guidance processor 106 may select the wayline and topographical data to be loaded. For example, the plurality of topographical data may comprise individual data sets corresponding to different fields. When the operator drives agricultural vehicle 102 into a particular area (e.g., field 104) the operator may select wayline 126 and the topographical data for field 104. In addition, when the operator drives agricultural vehicle 102 into field 104, auto-guidance processor 106 may determine that agricultural vehicle 102 is located in field 104 and automatically select wayline 126 and the appropriate topographical data.

From stage 310 where the wayline and topographical data are loaded, method 300 may proceed to stage 315 where auto-guidance processor 106 may superimpose the topographical data onto the wayline. For example, wayline 126 may be usable in different fields. Therefore, when wayline 126 is loaded into auto-guidance processor 106, topographical data may not be associated with wayline 126. Superimposing the topographical data onto wayline 126 may allow auto-guidance processor 106 to determine agricultural vehicle 102's orientation at future times. For instance, having the topographical data superimposed onto wayline 126 may allow auto-guidance processor 106 to determine agricultural vehicle 102's inclination angle when agricultural vehicle 102 reaches a given point along wayline 126. Agricultural vehicle 102's inclination angle may be measured relative to horizontal or vertical. In addition, agricultural vehicle 102's inclination angle may be measured in the pitch, roll, and yaw axes.

From stage 315 where the topographical data is superimposed onto the wayline, method 300 may proceed to stage 320 where auto-guidance processor 106 may calculate a maximum speed based upon the topographical data. For example, auto-guidance processor 106 may use the topographical data and wayline 126 to determine that agricultural vehicle 102 may be on a hillside and turning. For instance, agricultural vehicle 102 may be traversing a steep hillside and, based on wayline 126, may turn to travel uphill. This configuration may place agricultural vehicle 102 in an unstable position if it is traveling too fast. As such, auto-guidance processor 106 may use agricultural vehicle 102's weight and balance information along with a calculated angle of inclination to determine the maximum speed.

The maximum speed may be for a localized portion of field 104, or for all of field 104. For instance, the maximum speed may be localized to areas where agricultural vehicle 102 is turning. In addition, the maximum speed may be for field 104 in its entirety.

From stage 320 where the maximum speed is calculated, method 300 may proceed to stage 325 where auto-guidance processor 106 may engage drive component 214. For example, auto-guidance processor 106 may send a signal to agricultural vehicle 102's engine and cause agricultural vehicle to move forward at a given speed (e.g., 10 mph). In addition, auto-guidance processor 106 may control the steering linkage and cause agricultural vehicle 102 to turn in various directions. For instance, once engaged, drive component 214 may cause agricultural vehicle 102 to traverse wayline 126 at the given speed.

From stage 325 where drive component 214 is engaged, method 300 may proceed to stage 330 where auto-guidance processor 106 may receive inclination data from inertial sensor system 220. Agricultural vehicle 102's inclination angle may be measured relative to horizontal or vertical axes. In addition, agricultural vehicle 102's inclination angle may be measured in the pitch, roll, and yaw axes. For example, inertial sensor system 220 may comprise a gyroscope and as agricultural vehicle 102 traverses wayline 126, inertial sensor system 220's gyroscope may measure agricultural vehicle 102 pitch and roll angles as well as changes in agricultural vehicle 102's pitch and roll angles.

Inertial sensor system 220 may then transmit the measurements or detected changes to auto-guidance processor 106. For instance, inertial sensor system 220 may measure agricultural vehicle 102's inclination angle at a given frequency (e.g., 60 Hz). Using the inclination angle measurements auto-guidance processor 106 and/or inertial sensor system 220 may calculate the inclination angle rate of change of agricultural vehicle 102.

From stage 330 where auto-guidance processor 106 receives the inclination data, method 300 may proceed to stage 335 where the maximum speed may be recalculated based upon the inclination data. For example, auto-guidance processor 106 may use the inclination data to determine that agricultural vehicle 102 may be on a hillside and/or turning. For instance, agricultural vehicle 102 may be traversing a steep hillside and, based on wayline 126, may turn to travel uphill. This configuration may place agricultural vehicle 102 in an unstable position if it is traveling too fast. As such, auto-guidance processor 106 may use agricultural vehicle 102's weight and balance information along with the inclination data to determine the maximum speed.

The maximum speed may be selected from the array stored in inclination data database 212. For instance, as agricultural vehicle 102 travels a hillside, it may have a fixed inclination angle. The array may contain a listing of maximum speeds for given inclination angles. For example, for an inclination angle of 3 degrees, the array may contain a corresponding maximum speed of 20 mph to be set as the maximum speed.

Furthermore, setting the maximum speed may comprise increasing and decreasing the maximum speed. For example, the maximum speed may be set at a current value of X mph. When a new maximum speed is set, it may be set at a higher or lower speed that X mph.

In addition, the array may contain maximum speeds for the inclination angle rates of change. For example, as agricultural vehicle 102 turns, its inclination angle may change. For instance, as agricultural vehicle 102 enters a turn it may pitch into and roll opposite the turn's direction. Inertial sensor system 220 may detect the changes in pitch and roll and send the rates of change to auto-guidance processor 106. Auto-guidance processor 106 may use the inclination angle rate of change to select the maximum speed from the array.

Furthermore, auto-guidance processor 106 may use a formula to calculate the maximum speed. For instance, the maximum speed may be a function of agricultural vehicle 102's weight, vehicle type (e.g., tractor, sprayer, etc.), wheelbase, inclination angle, the inclination angle's rate of change, etc. Auto-guidance processor 106 may receive the inputs to the function and calculate the maximum speed. Furthermore, calculating the maximum speed may comprise increasing and decrease the maximum speed.

Agricultural vehicle 102's operating speed does not have to be the maximum speed. For example, the agricultural vehicle 102's operator may choose to operate agricultural vehicle 102 at a speed below the maximum speed. However, the maximum speed may be an upper limit that the operator and/or auto-guidance processor 106 may operate agricultural vehicle 102.

From stage 335 where auto-guidance processor 106 recalculates the maximum speed, method 300 may proceed to subroutine 340 where auto-guidance processor 106 may alter agricultural vehicle 102's speed. Auto-guidance processor 106 may alter agricultural vehicle 102's speed as it traverses wayline 126 based upon the inclination data and/or the topographical data. For example, as agricultural vehicle 102 enters a turn, auto-guidance processor 106 receive the inclination data and may slow agricultural vehicle 102's speed based upon the inclination data. In addition, as agricultural vehicle 102 exits the turn, auto-guidance processor 106 may increase agricultural vehicle 102's speed based upon received inclination data.

In subroutine 340, auto-guidance processor 106 may alter agricultural vehicle 102's speed based upon a rate of change of inclination angle. For example, as agricultural vehicle 102 transitions from relatively flat terrain or during a turn, agricultural vehicle 102's inclination angle may change. Depending on the maximum speed for the change in inclination angle, auto-guidance processor 106 may slow agricultural vehicle 102 if its current speed exceeds the maximum speed. In addition, auto-guidance processor 106 may increase agricultural vehicle 102's speed if its current speed is below the maximum speed.

Auto-guidance processor 106 may alter agricultural vehicle 102's speed based upon a roll rate. For example, agricultural vehicle 102 may be traveling on a straight portion of wayline 126, which may also be undulating terrain. As agricultural vehicle 102 travels wayline 126 it may roll from side to side causing a roll rate. Auto-guidance processor 106 may receive a roll rate and calculate or select a maximum speed based on the roll rate. In stage 330, auto-guidance processor 106 may slow agricultural vehicle 102 if its current speed exceeds the maximum speed. In addition, auto-guidance processor 106 may increase agricultural vehicle 102's speed if its current speed is below the maximum speed.

Auto-guidance processor 106 may alter agricultural vehicle 102's speed based upon a maximum inclination angle. For example, agricultural vehicle 102 may be traveling on relatively flat terrain at a maximum speed and may transition to inclined terrain. The maximum speed may have a maximum inclination angle associated with it. For instance, while operating at 20 mph agricultural vehicle 102 may have a maximum inclination angle of 5 degrees. As agricultural vehicle 102 travels wayline 126, its inclination angle may increase above the maximum inclination angle. Auto-guidance processor 106 may receive agricultural vehicle 102's current inclination angle. Auto-guidance processor 106 may slow agricultural vehicle 102 if the received inclination angle exceeds the maximum inclination angle. In addition, auto-guidance processor 106 may increase agricultural vehicle 102's speed if its current inclination angle is below the maximum inclination angle.

Moreover, auto-guidance processor 106 may alter agricultural vehicle 102's speed as it traverses wayline 126 based upon the topographical data. For example, as agricultural vehicle 102 approaches a turn, auto-guidance processor 106 may slow agricultural vehicle 102's speed. As agricultural vehicle 102 exits the turn, auto-guidance processor 106 may increase agricultural vehicle 102's speed.

Furthermore, auto-guidance processor 106 may use the topographical data to calculate agricultural vehicle 102's projected inclination angle and adjust agricultural vehicle 102's speed. For instance, the topographical data may indicate the terrain proximate eighth contour line 124 may be relatively flat and agricultural vehicle 102 may have a small projected inclination angle when operating proximate eighth contour line 124. As such, auto-guidance processor 106 may increase agricultural vehicle 102's speed when proximate eighth contour line 124. Relatively flat terrain may be terrain that has a slope less than a certain angle (e.g., 5 degrees relative to horizontal), or has few peaks and valleys within a given distance. For example, terrain that has no peaks and valleys within 100 yards of a given point may be said to be relatively flat.

Using the topographical data and wayline 126, auto-guidance processor 106 may be able to predict a turn into an inclined surface and adjust agricultural vehicle 102's speed to minimize instability. The topographical data may indicate that the terrain between third contour line 114 and fourth contour line 116 may have a steep incline. The possible steep incline may be indicated by the slop of the terrain depicted in FIG. 1A between third contour line 114 and fourth contour line 116. If agricultural vehicle 102 is traversing wayline 126 in a direction from first contour line 110 toward eighth contour line 124, agricultural vehicle 102 may turn into the steep incline as indicated by the point where wayline 126, third contour line 114, and section line 1A-1A cross. Turning into the inclined surface at a high speed may cause agricultural vehicle 102 to become unstable and possibly rollover. As such, auto-guidance processor 106 may slow agricultural vehicle 102 as agricultural vehicle 102 approaches the turn.

From subroutine 340 where auto-guidance processor 106 alters agricultural vehicle 102's speed, method 300 may end at stage 345. Method 300 may repeat at regular intervals. For example, method 300 may repeat every 1 second, 10 seconds, etc.

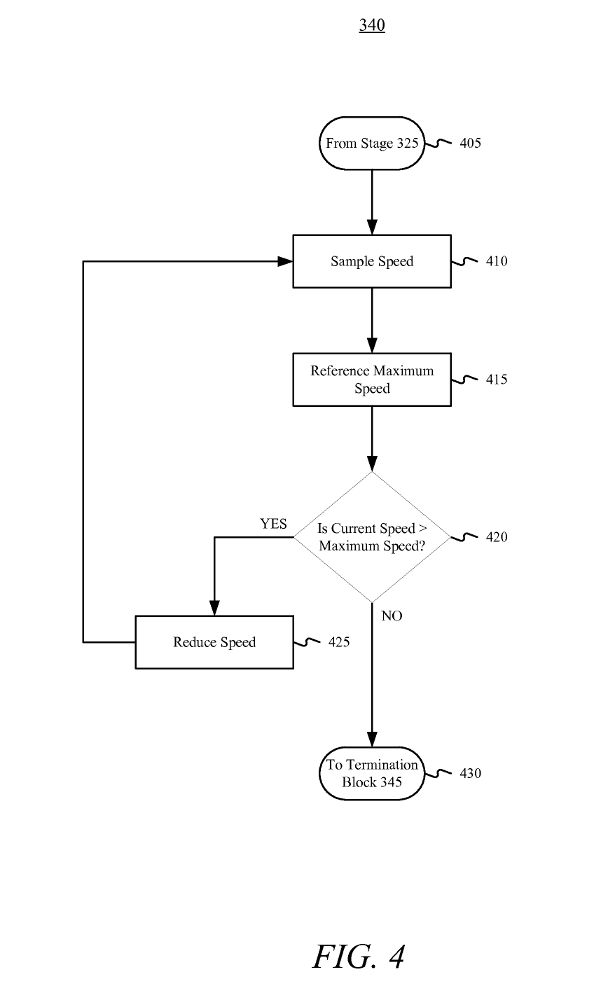

FIG. 4 is a flow chart setting forth the general stages involved in subroutine 340 for altering the speed of agricultural vehicle 102. Subroutine 340 may be implemented using, for example, auto-guidance processor 106 as described in more detail above. Ways to implement the stages of subroutine 340 will be described in greater detail below.

Subroutine 340 may begin at starting block 405 and proceed to stage 410 where auto-guidance processor 106 may sample a current speed of agricultural vehicle 102. For example, auto-guidance processor 106 may receive agricultural vehicle 102's speed from drive component 214. In addition, auto-guidance processor 106 may calculate agricultural vehicle 102's speed based on position data received from positioning system 216.

From stage 410 where auto-guidance processor 106 samples the current speed, subroutine 340 may proceed to stage 415 where auto-guidance processor 106 may reference the maximum speed. For example, in stage 415 auto-guidance processor 106 may reference the maximum speed calculated in stage 335. From stage 415 where auto-guidance processor 106 references the maximum speed, subroutine 340 may proceed to decision block 420 where auto-guidance processor 106 may determine if agricultural machine 102's speed is above the maximum speed. Auto-guidance processor 106 may determine of agricultural machine 102's speed is greater than the maximum speed using arithmetic operations.

If the current speed is greater than the maximum speed, subroutine 340 may proceed to stage 425 where auto-guidance processor 106 may reduce the speed of agricultural machine 102. For example, auto-guidance processor 106 may send a signal to drive component 212. The signal may be configured to cause the drive component to reduce the engine output. The engine output may be reduced by reducing engine rpms, reducing the fuel flowrate, and/or constricting the air intake to the engine. After reducing the engine output, subroutine may proceed to repeat stage 410, stage 415, and decision block 420 to determine if the reduction in speed has reduced agricultural vehicle 102's speed below the maximum speed. If the current speed is below the maximum speed, subroutine may terminate and return to termination block 345 at termination block 430.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A method comprising:
loading topographical data of an area where an agricultural machine is located, the topographical data of the area;
traversing a wayline at a speed, the wayline defining a path for an agricultural machine to travel within the area, the speed based upon the topographical data;
receiving inclination data of the agricultural machine as the agricultural machine traverse the wayline; and
altering the speed of the agricultural machine as it traverses the wayline based on the inclination data.

2. The method of claim 1 further comprising:
calculating a maximum speed based on the topographical data; and
recalculate the maximum speed based on the inclination data.

3. The method of claim 1, wherein altering the speed of the agricultural machine comprises first altering the speed based on the topographical data and then based on the inclination data.

4. The method of claim 1,
wherein receiving the inclination data comprises receiving a roll rate of the agricultural machine, and
wherein altering the speed comprises reducing the speed of the agricultural machine when the roll rate exceeds a maximum roll rate.

5. The method of claim 1,
wherein receiving the inclination data comprises receiving an angle of inclination of the agricultural machine, and
wherein altering the speed of the agricultural machine comprises reducing the speed when the angle of inclination exceeds a maximum angle of inclination.

6. The method of claim 1,
wherein receiving the inclination data comprises receiving an angle of inclination of the agricultural machine, and
wherein altering the speed of the agricultural machine comprises increasing the speed when the angle of inclination is below a maximum angle of inclination.

7. The method of claim 1,
wherein receiving the inclination data comprises receiving an angle of inclination of the agricultural machine, and
wherein altering the speed of the agricultural machine comprises setting a maximum speed of the agricultural machine based on the angle of inclination.

8. An apparatus comprising:
inertial sensor system attached to the apparatus;
a drive component operative to propel the apparatus; and
an auto-guidance processor coupled to the drive component and the inertial sensor system, the auto-guidance processor operative to:
load topographical data of an area where the apparatus is located, the topographical data defining an elevation profile of the area,
engage the drive component to propel the apparatus along a wayline at a speed, the wayline defining a path for the apparatus to follow,
receive inclination data from the inertial sensor system, and
alter the speed as the apparatus follows the wayline based on the inclination data and the topographical data.

9. The apparatus of claim 8, wherein the auto-guidance processor is further operative to:
calculate a maximum speed based on the topographical data; and
recalculate the maximum speed based on the inclination data.

10. The apparatus of claim 8, wherein the auto-guidance processor operative to alter the speed of the agricultural machine comprises the auto-guidance processor operative to first altering the speed based on the elevation profile and then based on the inclination data.

11. The apparatus of claim 8,
wherein the auto-guidance processor operative to receive the inclination data comprises the auto-guidance processor operative to receive a roll rate of the apparatus, and
wherein the auto-guidance processor operative to alter the speed comprises the auto-guidance processor operative to reduce the speed of the apparatus when the roll rate exceeds a maximum roll rate.

12. The apparatus of claim 8,
wherein the auto-guidance processor operative to receive the inclination data comprises the auto-guidance processor operative to receive an angle of inclination of the apparatus, and
wherein the auto-guidance processor operative to alter the speed of the apparatus comprises the auto-guidance processor operative to reduce the speed when the angle of inclination exceeds a maximum angle of inclination.

13. The apparatus of claim 8,
wherein the auto-guidance processor operative to receive the inclination data comprises the auto-guidance processor operative to receive an angle of inclination of the apparatus, and
wherein the auto-guidance processor operative to alter the speed of the apparatus comprises the auto-guidance processor operative to increase the speed when the angle of inclination is below a maximum angle of inclination.

14. The apparatus of claim 8,
wherein the auto-guidance processor operative to receive the inclination data comprises the auto-guidance processor operative to receive an angle of inclination of the apparatus, and
wherein the auto-guidance processor operative to alter the speed of the apparatus comprises the auto-guidance processor operative to set a maximum speed of the apparatus based on the angle of inclination.

15. An apparatus comprising:
a memory storage; and
a processing unit coupled to the memory storage, wherein the processing unit is operative to:
load topographical data of an area where the apparatus is located, the topographical data of the area,
engage a drive component to propel the apparatus along a wayline at a speed, the wayline defining a path for the apparatus to follow,
receive inclination data from an inertial sensor system, and
alter the speed as the apparatus follows the wayline based on the inclination data and the topographical data.

16. The apparatus of claim 15, wherein the processing unit is further operative to:
calculate a maximum speed based on the topographical data; and
recalculate the maximum speed based on the inclination data.

17. The apparatus of claim 15, wherein the processing unit operative to alter the speed of the agricultural machine comprises the processing unit operative to first altering the speed based on the elevation profile and then based on the inclination data.

18. The apparatus of claim 15,
wherein the processing unit operative to receive the inclination data comprises the processing unit operative to receive a roll rate of the apparatus, and
wherein the processing unit operative to alter the speed comprises the processing unit operative to reduce the speed of the apparatus when the roll rate exceeds a maximum roll rate.

19. The apparatus of claim 15,
wherein the processing unit operative to receive the inclination data comprises the processing unit operative to receive an angle of inclination of the apparatus, and
wherein the processing unit operative to alter the speed of the apparatus comprises the processing unit operative to reduce the speed when the angle of inclination exceeds a maximum angle of inclination.

20. The apparatus of claim 15,
wherein the processing unit operative to receive the inclination data comprises the processing unit operative to receive an angle of inclination of the apparatus, and
wherein the processing unit operative to alter the speed of the apparatus comprises the processing unit operative to increase the speed when the angle of inclination is below a maximum angle of inclination.
